(19) United States
(12) Patent Application Publication
(10) Pub. No.: US 2023/0348701 A1
(43) Pub. Date: Nov. 2, 2023

(54) RUBBER COMPOSITION

(71) Applicant: COMPAGNIE GENERALE DES ETABLISSEMENTS MICHELIN, Clermont-Ferrand (FR)

(72) Inventors: JOSE-CARLOS ARAUJO DA SILVA, Clermont-Ferrand (FR); MAXIME PRAS, Clermont-Ferrand (FR); BENOIT CEREDE, Clermont-Ferrand (FR); ANTOINE PERRIOT, Clermont-Ferrand (FR); SIMON DURIEZ, Clermont-Ferrand (FR)

(21) Appl. No.: 18/007,841

(22) PCT Filed: Jun. 3, 2021
(86) PCT No.: PCT/FR2021/051006

§ 371 Date: Dec. 2, 2022

(30) Foreign Application Priority Data
Jun. 4, 2020 (FR) FR2005857

(51) Int. Cl. C08C 19/25; C08K 3/36; C08K 5/548; C08K 5/31; C08K 3/06; B60C 1/00; C08L 9/06; C08C 19/22; C08K 3/04

(52) U.S. Cl. CPC C08L 9/06; B60C 1/0016; C08C 19/22; C08C 19/25; C08K 3/04; C08K 3/06; C08K 3/36; C08K 5/31; C08K 5/548; C08L 2205/025

(57) ABSTRACT

A rubber composition is based on at least one non-functionalized first diene elastomer E1 having a glass transition temperature TgE1, one functionalized second diene elastomer E2 having a glass transition temperature TgE2, a reinforcing filler capable of interacting with the functionalized diene elastomer E2 and a crosslinking system, in which: the glass transition temperature TgE1 is above or equal to -50° C., the glass transition temperature TgE2 satisfies the mathematical relationship TgE2 ≤ TgE1-23° C., and the content of the non-functionalized diene elastomer E1 is greater than or equal to 50 phr. A tread and/or a pneumatic or non-pneumatic tire may comprise at least one composition as defined above.

The field of the present invention is that of rubber compositions reinforced with a reinforcing filler, in particular used in the building of pneumatic or non-pneumatic vehicle tyres, more particularly used for the manufacture of treads.

A tread for a pneumatic or non-pneumatic tyre has to meet, in a known way, a large number of often conflicting technical requirements, including low rolling resistance, high wear resistance, and also high grip on wet ground.

This compromise in properties, in particular from the viewpoint of the rolling resistance and the wear resistance, has been able to be improved in recent years with regard to energy-saving “Green Tyres”, intended in particular for passenger vehicles, by virtue in particular of the use, as tread, of novel low-hysteresis rubber compositions having the characteristic of being reinforced predominantly by specific inorganic fillers, described as reinforcing fillers, in particular by highly dispersible silicas (HDSs), capable of rivalling, from the viewpoint of the reinforcing power, conventional tyre-grade carbon blacks. However, the presence of a high silica content in these rubber compositions is not optimal for the wet grip performance of the tyre; this grip being lower than for weakly filled compositions.

It is known that the grip of a pneumatic tyre on wet ground is achieved by increasing the contact area of the tread on the ground on which it is running, in particular by using a deformable material for the tread, in this case a deformable rubber composition. One way of making a rubber composition more deformable is to add a large amount of plasticizers thereto. However, a highly deformable rubber composition has the drawback of having a broad hysteresis potential. Yet improving the rolling resistance involves lowering the hysteresis losses.

Thus, the rubber composition of the tread must satisfy two conflicting requirements, namely having a maximum hysteresis potential in order to satisfy the requirement of grip and having a hysteresis that is as low as possible in order to satisfy the requirement of rolling resistance.

One aim of the present invention is thus to propose novel rubber compositions, in particular for treads, which resolve in particular the aforementioned drawbacks; exhibiting in particular improved hysteresis properties while maintaining or even improving their wet grip performance.

This aim is achieved in that the applicant has just surprisingly discovered that a specific combination of diene elastomers having a rubber compound having a defined difference in glass transition temperature makes it possible to overcome the aforementioned drawbacks. Specifically, when a rubber composition comprises at least one non-functionalized diene elastomer E1 having a glass transition temperature TgE1 above or equal to -50° C., this elastomer

E1 being present at a content greater than equal to 50 phr, and at least one functionalized second diene elastomer E2 having a glass transition temperature TgE2 that satisfies the mathematical relationship TgE2 ≤ TgE1-23° C.; then this composition is provided with excellent rolling resistance while retaining good grip on wet ground.

Thus, a first subject of the present invention relates to a rubber composition based on at least one non-functionalized first diene elastomer E1 having a glass transition temperature TgE1, one functionalized second diene elastomer E2 having a glass transition temperature TgE2, a reinforcing filler capable of interacting with the functionalized diene elastomer E2 and a crosslinking system, in which:
the glass transition temperature TgE1 is above or equal to -50° C.,
the glass transition temperature TgE2 satisfies the mathematical relationship TgE2 ≤ TgE1-23° C., and
the content of the non-functionalized diene elastomer E1 is greater than or equal to 50 phr.

Advantageously, the glass transition temperature TgE2 may satisfy the mathematical relationship TgE2≤ TgE1-28° C., more preferentially TgE2≤ TgE1-30° C.

Advantageously, the glass transition temperature TgE2 may satisfy the mathematical relationship TgE2≥ TgE1-65° C., more preferentially TgE2 ≥ TgE1-50° C., more preferentially still TgE2 ≥ TgE1-45° C.

Advantageously, the glass transition temperature TgE1 may be within a range extending from -50° C. to 0° C., more preferentially from -40° C. to 0° C., more preferentially from -30° C. to 0° C.

Advantageously, the glass transition temperature TgE2 may be within a range extending from -110° C. to -23° C., preferably extending from -100° C. to -28° C., more preferentially extending from -95° C. to -30° C.

Advantageously the content of the non-functionalized diene elastomer E1 may be within a range extending from 50 phr to 70 phr, preferably from 55 phr to 70 phr, more preferentially from 55 phr to 65 phr.

Advantageously, the content of reinforcing filler may be within a range extending from 20 to 100 phr, preferably extending from 30 to 90 phr, more preferentially still extending from 40 to 90 phr.

Advantageously, the reinforcing filler may predominantly comprise at least one inorganic reinforcing filler, more preferentially still may comprise predominantly at least one silica. Preferentially, the inorganic reinforcing filler, preferably silica, represents more than 50% by weight, preferably more than 55% by weight of the total weight of the reinforcing filler in the rubber composition. More preferentially still, the reinforcing filler may predominantly comprise at least one silica may also comprise at least one carbon black; the carbon black being in the minority. Preferentially, the rubber composition may further comprise an agent for coupling the reinforcing filler with the diene elastomer. Preferentially, this coupling agent may be an organosilane polysulfide.

Advantageously, the non-functionalized diene elastomer E1 may be selected from the group consisting of synthetic polyisoprenes, polybutadienes, butadiene/styrene copolymers, butadiene/isoprene copolymers, isoprene/styrene copolymers and butadiene/styrene/isoprene copolymers. Preferentially, the non-functionalized diene elastomer E1 is selected from polybutadienes and styrene/butadiene copolymers. More preferentially still, the non-functionalized diene elastomer E1 is a styrene/butadiene copolymer.

Advantageously, the functionalized diene elastomer E2 may be selected from the group consisting of natural rubber, synthetic polyisoprenes, polybutadienes, butadiene/styrene copolymers, butadiene/isoprene copolymers, isobutene/isoprene copolymers, isoprene/styrene copolymers and butadiene/styrene/isoprene copolymers. Preferentially, the functionalized diene elastomer E2 is selected from polybutadienes and styrene/butadiene copolymers. More preferentially still, the functionalized diene elastomer E2 is a styrene/butadiene copolymer.

Advantageously, the functionalized diene elastomer E2 may comprise at least one chemical function capable of interacting with the reinforcing filler, the chemical function comprising at least one heteroatom selected from the group consisting of nitrogen, sulfur, oxygen, phosphorus, tin and silicon.

Advantageously, the reinforcing filler predominantly comprises a reinforcing inorganic filler, preferentially a silica, and the functionalized diene elastomer E2 may comprise at least one chemical function capable of interacting with the reinforcing inorganic filler, the chemical function comprising at least one heteroatom selected from the group consisting of nitrogen, sulfur, oxygen and phosphorus.

Advantageously, the chemical function capable of interacting with the reinforcing filler may be a polar function comprising at least one oxygen atom.

Advantageously, the polar function may be selected from the group consisting of silanol, alkoxysilanes optionally bearing an amine group, epoxide, ethers, esters, carboxylic acids and hydroxyl.

Advantageously, the functionalized diene elastomer E2 may comprise a polar function which is a silanol. Preferentially, the silanol may be located at the chain end or in the middle of the chain of the main chain of the functionalized diene elastomer, more preferentially the silanol being located at the chain end of the main chain of the functionalized diene elastomer.

Advantageously, the functionalized diene elastomer E2 may comprise a polar function which is an alkoxysilane optionally bearing an amine group. Preferentially, the alkoxysilane optionally bearing an amine group may be located at the chain end or in the middle of the chain of the main chain of the functionalized diene elastomer E2, more preferentially the alkoxysilane group optionally bearing an amine group is located in the middle of the chain of the main chain of the functionalized diene elastomer E2. Preferentially, the amine group may be a tertiary amine.

Advantageously, the content of the functionalized diene elastomer E2 in the composition of the invention is less than or equal to 40 phr, more preferentially is within a range extending from 30 phr to 50 phr, preferably from 30 phr to 45 phr, more preferentially from 35 phr to 45 phr.

Advantageously, the content of the non-functionalized diene elastomer E1 in the composition of the invention is within a range extending from 50 phr to 70 phr and the content of the functionalized diene elastomer E2 in the composition of the invention is within a range extending from 30 phr to 50 phr. Advantageously, the content of the non-functionalized diene elastomer E1 in the composition of the invention is within a range extending from 55 phr to 70 phr and the content of the functionalized diene elastomer E2 in the composition of the invention is within a range extending from 30 phr to 45 phr.

Advantageously, the rubber composition as defined above further comprises at least one plasticizer.

Advantageously, the rubber composition as defined above and its preferred embodiments can be obtained according to a manufacturing process which comprises the following steps:
introducing the non-functionalized diene elastomer E1 having an abovementioned glass transition temperature TgE1 and, where appropriate, the other ingredients such as a plasticizer into an internal mixer and carrying out thermomechanical working up to a maximum temperature of 200° C. in order to obtain a first masterbatch;
introducing the functionalized diene elastomer E2 having an abovementioned glass transition temperature TgE2, the reinforcing filler, and, where appropriate, the coupling agent and the other ingredients such as a plasticizer, into an internal mixer and carrying out thermomechanical working up to a maximum temperature of 200° C. in order to obtain a second masterbatch;
introducing the first and the second masterbatch obtained in the preceding steps into an internal mixer and carrying out thermomechanical working up to a maximum temperature of 180° C. in order to obtain a mixture;
recovering the mixture from the preceding step and cooling it to a temperature below or equal to 110° C.; and
incorporating the crosslinking system into the cooled mixture and kneading up to a maximum temperature of less than 110° C., preferentially of less than 80° C., and recovering the rubber composition.

Another subject of the present invention relates to a tread comprising at least one composition defined above.

Another subject of the present invention relates to a tyre comprising at least one composition defined above or else comprising at least one tread as defined above.

A first subject of the present invention relates to a rubber composition based on at least one non-functionalized first diene elastomer E1 having a glass transition temperature TgE1, one functionalized second diene elastomer E2 having a glass transition temperature TgE2, a reinforcing filler capable of interacting with the functionalized diene elastomer E2 and a crosslinking system, in which:
the glass transition temperature TgE1 is above or equal to -50° C.,
the glass transition temperature TgE2 satisfies the mathematical relationship TgE2 ≤ TgE1-23° C., and
the content of the non-functionalized diene elastomer E1 is greater than or equal to 50 phr.

The expression “rubber composition based on” should be understood to mean a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the non-crosslinked state.

For the purposes of the present invention, the expression “part by weight per hundred parts by weight of elastomer” (or phr) should be understood to mean the part by weight per hundred parts by weight of elastomer of the composition.

In the present document, unless expressly indicated otherwise, all the percentages (%) indicated are percentages (%) by weight.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b).

When reference is made to a “predominant” compound, this is understood to mean, for the purposes of the present invention, that this compound is predominant among the compounds of the same type in the rubber composition, that is to say that it is the one which represents the greatest amount by weight among the compounds of the same type. Thus, for example, a predominant elastomer is the elastomer representing the greatest weight relative to the total weight of the elastomers in the composition. In the same way, a “predominant” filler is the one representing the greatest weight among the fillers of the composition. By way of example, in a system comprising just one elastomer, the latter is predominant within the meaning of the present invention and, in a system comprising two elastomers, the predominant elastomer represents more than half of the weight of the elastomers. By contrast, a “minor” compound is a compound which does not represent the greatest fraction by weight among the compounds of the same type. Preferably, the term “predominant” is understood to mean present at more than 50%, preferably more than 60%, 70%, 80%, 90%, and more preferentially the “predominant” compound represents 100%.

The compounds mentioned in the description that comprise carbon may be of fossil origin or may be biobased. In the latter case, they may partially or completely result from biomass or be obtained from renewable starting materials resulting from biomass. Polymers, plasticizers, fillers, and the like, are concerned in particular.

A “diene” elastomer (or, without distinction, rubber), whether natural or synthetic, should be understood, in a known way, as meaning an elastomer composed, at least in part (i.e., a homopolymer or a copolymer), of diene monomer units (monomers bearing two conjugated or non-conjugated carbon-carbon double bonds).

An “elastomeric matrix” is understood to mean all of the elastomers forming the rubber composition of the invention.

Diene elastomers can be classified in two categories: “essentially unsaturated” or “essentially saturated”. The term “essentially unsaturated” is understood to mean generally a diene elastomer resulting at least in part from conjugated diene monomers having a content of units of diene origin (conjugated dienes) which is greater than 15% (mol%); thus it is that diene elastomers such as butyl rubbers or copolymers of dienes and of α-olefins of EPDM type do not come within the preceding definition and can in particular be described as “essentially saturated” diene elastomers (low or very low content, always less than 15 mol%, of units of diene origin).

A diene elastomer capable of being used in the compositions in accordance with the invention is intended more particularly to mean:
any homopolymer of a conjugated or non-conjugated diene monomer having from 4 to 18 carbon atoms;
any copolymer of a conjugated or non-conjugated diene having from 4 to 18 carbon atoms and of at least one other monomer.

The other monomer can be an olefin or a conjugated or non-conjugated diene.

Conjugated dienes that are suitable include conjugated dienes containing from 4 to 12 carbon atoms, in particular 1,3-dienes, notably such as 1,3-butadiene and isoprene.

Non-conjugated dienes that are suitable include non-conjugated dienes containing from 6 to 12 carbon atoms, such as 1,4-hexadiene, ethylidenenorbornene or dicyclopentadiene.

Olefins that are suitable include vinylaromatic compounds containing from 8 to 20 carbon atoms and aliphatic α-monoolefins containing from 3 to 12 carbon atoms.

Vinylaromatic compounds that are suitable include, for example, styrene, ortho-, meta- or para-methylstyrene, the “vinyltoluene” commercial mixture or para-(tert-butyl)styrene.

More particularly, the diene elastomer is:
any homopolymer of a conjugated diene monomer, in particular any homopolymer obtained by polymerization of a conjugated diene monomer having from 4 to 12 carbon atoms;
any copolymer obtained by copolymerization of one or more conjugated dienes with one another or with one or more vinylaromatic compounds having from 8 to 20 carbon atoms;
a copolymer of isobutene and of isoprene (butyl rubber) and also the halogenated versions, in particular chlorinated or brominated versions, of this type of copolymer.

The rubber composition according to the invention comprises at least one non-functionalized first diene elastomer E1 having a glass transition temperature TgE1 above or equal to -50° C. and at least one functionalized second diene elastomer E2 having a glass transition temperature TgE2, the glass transition temperature TgE2 satisfying the mathematical relationship TgE2 ≤ TgE1-23° C.; the non-functionalized diene elastomer E1 being present at a content greater than or equal to 50 phr. Surprisingly, this combination makes it possible to obtain a rubber composition which has excellent hysteresis properties (therefore reduced rolling resistance) while having remarkable wet grip properties.

The glass transition temperatures TgE1 and TgE2 are measured according to the standard ASTM D3418:2008.

For the purposes of the present invention, “a functionalized diene elastomer” is understood to mean a diene elastomer, whether natural or synthetic, which bears a chemical function capable of interacting with a reinforcing filler. The chemical function capable of interacting with the reinforcing filler can be in particular a heteroatom or a group of atoms comprising at least one heteroatom chosen from nitrogen, sulfur, oxygen, phosphorus, tin and silicon.

For the purposes of the present invention, “a non-functionalized diene elastomer” is understood to mean a diene elastomer, whether natural or synthetic, which does not bear a chemical function capable of interacting with a reinforcing filler. Preferentially, the non-functionalized diene elastomer may consist essentially of carbon and hydrogen atoms. It may comprise no heteroatoms or else heteroatoms in amounts which are impurities and which result from its method of synthesis.

### Diene Elastomer E1

The diene elastomer E1 is non-functionalized and has a glass transition temperature TgE1 above or equal to -50° C. More preferentially, the glass transition temperature TgE1 is within a range extending from -50° C. to 0° C., more preferentially from -40° C. to 0° C., more preferentially from -30° C. to 0° C.

The non-functionalized diene elastomer E1 may be any abovementioned diene elastomer provided that its glass transition temperature TgE1 is above or equal to -50° C.

Preferentially, the non-functionalized diene elastomer E1 is selected from the group consisting of synthetic polyisoprenes, polybutadienes, butadiene/styrene copolymers, butadiene/isoprene copolymers, isoprene/styrene copolymers and butadiene/styrene/isoprene copolymers. Preferentially, the non-functionalized diene elastomer E1 is selected from polybutadienes and styrene/butadiene copolymers. Advantageously, the non-functionalized diene elastomer E1 is a styrene/butadiene copolymer.

Suitable as non-functionalized diene elastomer E1 in particular are the butadiene/styrene copolymers having a Tg within a range extending from -50° C. to 0° C., a styrene content within a range extending from 1% to 30% by weight relative to the weight of the copolymer, a vinyl-1,2 butadiene content within a range extending from 14% to 93% by weight relative to the weight of the copolymer, a cis-1,4 butadiene content within a range extending from 2% to 22% by weight relative to the weight of the copolymer and a trans-1,4 butadiene content within a range extending from 3% to 33% by weight relative to the weight of the copolymer.

Suitable as non-functionalized diene elastomer E1 in particular are the polybutadienes having a Tg within a range extending from -50° C. to 0° C., a vinyl-1,2 butadiene content within a range extending from 52% to 95% by weight relative to the weight of the copolymer, a cis-1,4 butadiene content within a range extending from 0% to 38% by weight relative to the weight of the copolymer and a trans-1,4 butadiene content within a range extending from 0% to 48% by weight relative to the weight of the copolymer.

Preferentially, the content of the non-functionalized diene elastomer E1 in the composition of the invention is within a range extending from 50 phr to 70 phr, preferably from 55 phr to 70 phr, more preferentially from 55 phr to 65 phr.

These non-functional diene elastomers are commercially available from suppliers such as Nippon Zeon, JSR, Bayer etc.

### Diene Elastomer E2

As seen above, the rubber composition comprises at least one diene elastomer E2, this elastomer being functionalized and having a glass transition temperature TgE2 that satisfies the mathematical relationship TgE2≤ TgE1-23° C.

Preferentially, the glass transition temperature TgE2 of the functionalized diene elastomer E2 satisfies the mathematical relationship TgE2≤ TgE1-28° C., more preferentially TgE2≤ TgE1- 30° C.

Advantageously, the glass transition temperature TgE2 of the functionalized diene elastomer E2 satisfies the mathematical relationship TgE2 ≥ TgE1-65° C., more preferentially TgE2 ≥ TgE1-50° C., more preferentially still TgE2≥ TgE1-45° C.

More advantageously still, the glass transition temperature TgE2 of the functionalized diene elastomer E2 is within a range extending from -110° C. to -23° C., preferably extending from -100° C. to -28° C., more preferentially extending from -95° C. to -30° C.

The functionalized diene elastomer E2 may be any abovementioned diene elastomer provided that it is functionalized and that its glass transition temperature satisfies the abovementioned mathematical relationship .

Preferentially, the functionalized diene elastomer E2 may be selected from the group consisting of natural rubber, synthetic polyisoprenes, polybutadienes, butadiene/styrene copolymers, butadiene/isoprene copolymers, isobutene/isoprene copolymers, isoprene/styrene copolymers and butadiene/styrene/isoprene copolymers. Preferentially, the functionalized diene elastomer E2 is selected from polybutadienes and styrene/butadiene copolymers. More preferentially still, the functionalized diene elastomer E2 is a styrene/butadiene copolymer.

Suitable as functionalized diene elastomer E2 in particular are the butadiene/styrene copolymers having a Tg within a range extending from -100° C. to -28° C., a styrene content within a range extending from 1% to 30% by weight relative to the weight of the copolymer, a a vinyl-1,2 butadiene content within a range extending from 0% to 74% by weight relative to the weight of the copolymer, a cis-1,4 butadiene content within a range extending from 10% to 40% by weight relative to the weight of the copolymer and a trans-1,4 butadiene content within a range extending from 15% to 59% by weight relative to the weight of the copolymer.

Suitable as functionalized diene elastomer E2 in particular are the polybutadienes having a Tg within a range extending from -110° C. to -23° C., a vinyl-1,2 butadiene content within a range extending from 0% to 82% by weight relative to the weight of the copolymer, a cis-1,4 butadiene content within a range extending from 0% to 100% by weight relative to the weight of the copolymer and a trans-1,4 butadiene content within a range extending from 0% to 100% by weight relative to the weight of the copolymer.

The functionalization of the diene elastomer E2 is known. It can be carried out during the synthesis of the diene elastomer or else after its synthesis by grafting chemical functions onto the monomers of the diene elastomer.

The functionalized diene elastomer E2 comprises at least one chemical function capable of interacting with the reinforcing filler, the chemical function comprising at least one heteroatom selected from the group consisting of nitrogen, sulfur, oxygen, phosphorus, tin and silicon. Mention may be made, by way of example, among these functions, of cyclic or non-cyclic primary, secondary or tertiary amines, isocyanates, imines, cyanos, thiols, carboxylates, epoxides or primary, secondary or tertiary phosphines. This interaction of the functionalized diene elastomer E2 with the reinforcing filler can be established for example by means of covalent bonds, hydrogen bonds, ionic and/or electrostatic bonds between the function(s) of the diene elastomer and the chemical functions present on the surface of the reinforcing filler.

Preferentially, when the reinforcing filler predominantly comprises a reinforcing inorganic filler, preferentially a silica, the functionalized diene elastomer E2 may comprise at least one chemical function capable of interacting with the reinforcing filler, the chemical function comprising at least one heteroatom selected from the group consisting of nitrogen, sulfur, oxygen and phosphorus.

Preferentially, the chemical function capable of interacting with the reinforcing filler of the diene elastomer E2 is a polar function comprising at least one oxygen atom.

Preferentially, the polar function may be selected from the group consisting of silanol, alkoxysilanes, alkoxysilanes bearing an amine group, epoxide, ethers, esters, carboxylic acids and hydroxyl. Such functionalized elastomers are known per se and are described notably in the following documents: FR2740778, US6013718, WO2008/141702, FR2765882, WO01/92402, WO2004/09686, EP1127909, US6503973, WO2009/000750 and WO 2009/000752.

The functionalized diene elastomer is preferably a diene elastomer comprising a polar function that is a silanol.

Preferentially, the silanol is located at the chain end or in the middle of the chain of the main chain of the functionalized diene elastomer.

Preferentially, the functionalized diene elastomer can be a diene elastomer (in particular an SBR) in which the silanol function is located at the chain end. This functionalized diene elastomer comprises, at one end of its main chain, a silanol function or a polysiloxane group bearing a silanol end of formula —(SiR₁R₂-O-)ₘH with m representing an integer ranging from 3 to 8, preferably 3, R₁ and R₂, which may be identical or different, represent an alkyl radical of 1 to 10 carbon atoms, preferably an alkyl radical containing 1 to 4 carbon atoms.

This type of elastomer may be obtained according to the processes described in document EP 0778311 and more particularly according to the process consisting, after a step of anionic polymerization, in functionalizing the living elastomer with a functionalization agent of cyclic polysiloxane type. As cyclic polysiloxanes, mention may be made of those corresponding to formula (V):

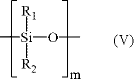

where m represents an integer ranging from 3 to 8, preferably 3, and R₁ and R₂, which may be identical or different, represent an alkyl radical of 1 to 10 carbon atoms, preferably an alkyl radical containing 1 to 4 carbon atoms. Among these compounds, mention may be made of hexamethylcyclotrisiloxane.

The functionalized diene elastomer E2 can be a diene elastomer (in particular an SBR) comprising a polar function which is an alkoxysilane optionally bearing another function, in particular an amine function. Preferentially, the alkoxysilane optionally bearing another function (preferably bearing an amine group) is located at the chain end or in the middle of the chain of the main chain of the functionalized diene elastomer, more preferentially the alkoxysilane group optionally bearing the amine group is located in the middle of the chain of the main chain of the functionalized diene elastomer.

Thus, the functionalized diene elastomer E2 may comprise within its structure at least one alkoxysilane group and at least one other function, the silicon atom of the alkoxysilane group being bonded to the elastomer chain(s), the alkoxysilane group optionally being partially or totally hydrolyzed to silanol.

According to certain variants, the alkoxysilane group is predominantly located at one end of the main chain of the elastomer.

According to other variants, the alkoxysilane group is predominantly located in the main elastomer chain, it will then be said that the diene elastomer is coupled or else functionalized in the middle of the chain, in contrast to the “chain end” position, although the group is not located precisely in the middle of the elastomer chain. The silicon atom of this function connects the two branches of the main chain of the diene elastomer.

The alkoxysilane group comprises a C1-C10 alkoxy radical, optionally partially or totally hydrolysed to hydroxyl, or even a C1-C8, preferably C1-C4 alkoxy radical, and is more preferentially methoxy and ethoxy.

The other function is preferably borne by the silicon of the alkoxysilane group, directly or via a spacer group defined as being an atom or a group of atoms. Preferentially, the spacer group is a saturated or unsaturated, cyclic or non-cyclic, linear or branched, divalent C₁-C₁₈ aliphatic hydrocarbon-based radical or a divalent C₆-C₁₈ aromatic hydrocarbon-based radical.

The other function is preferably a function comprising at least one heteroatom chosen from N, S, O or P. Mention may be made, by way of example, among these functions, of cyclic or non-cyclic primary, secondary or tertiary amines, isocyanates, imines, cyanos, thiols, carboxylates, epoxides or primary, secondary or tertiary phosphines.

Mention may thus be made, as secondary or tertiary amine function, of amines substituted by C1-C10 alkyl, preferably C1-C4 alkyl, radicals, more preferentially a methyl or ethyl radical, or else of cyclic amines forming a heterocycle containing a nitrogen atom and at least one carbon atom, preferably from 2 to 6 carbon atoms. For example, the methylamino-, dimethylamino-, ethylamino-, diethylamino-, propylamino-, dipropylamino-, butylamino-, dibutylamino-, pentylamino-, dipentylamino-, hexylamino-, dihexylamino- or hexamethyleneamino- groups, preferably the diethylamino- and dimethylamino- groups, are suitable. Mention may be made, as imine function, of ketimines. For example, the (1,3-dimethylbutylidene)amino-, (ethylidene)amino-, (1-methylpropylidene)amino-, (4-N,N-dimethylaminobenzylidene)amino-, (cyclohexylidene)amino-, dihydroimidazole and imidazole groups are suitable. Mention may thus be made, as carboxylate function, of acrylates or methacrylates. Such a function is preferably a methacrylate. Mention may be made, as epoxide function, of the epoxy or glycidyloxy groups. Mention may be made, as secondary or tertiary phosphine function, of phosphines substituted by C1-C10 alkyl, preferably C1-C4 alkyl, radicals, more preferentially a methyl or ethyl radical, or else diphenylphosphine. For example, the methylphosphino-, dimethylphosphino-, ethylphosphino-, diethylphosphino, ethylmethylphosphino- and diphenylphosphino- groups are suitable.

The other function is preferably a tertiary amine, more preferentially a diethylamino- or dimethylamino- group.

The alkoxysilane group can be represented by the formula:

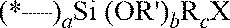

in which:
*represents the bond to an elastomer chain;
the radical R represents a substituted or unsubstituted C1-C10, or even C1-C8, alkyl radical, preferably a C1-C4 alkyl radical, more preferentially methyl and ethyl;
in the alkoxyl radical(s) of formula -OR′, which are optionally partially or totally hydrolysed to hydroxyl, R′ represents a substituted or unsubstituted C1-C10, or even C1-C8, alkyl radical, preferably a C1-C4 alkyl radical, more preferentially methyl and ethyl;
X represents a group including the other function;
a is 1 or 2, b is 1 or 2, and c is 0 or 1, with the proviso that a+b+c =3.

This type of elastomer is mainly obtained by functionalizing a living elastomer resulting from an anionic polymerization with a compound comprising an alkoxysilane group, in particular chosen from trialkoxysilane and dialkoxyalkylsilane compounds substituted by a group comprising another function bonded directly or via a spacer group to the silicon atom, the function and the spacer group being as defined above. It should be specified that it is known to those skilled in the art that, when an elastomer is modified by reaction of a functionalization agent with the living elastomer resulting from a step of anionic polymerization, a mixture of modified entities of this elastomer is obtained, the composition of which depends on the modification reaction conditions and especially on the proportion of reactive sites of the functionalization agent relative to the number of living elastomer chains. This mixture comprises entities which are functionalized at the chain end, coupled, star-branched and/or non-functionalized.

Preferentially, the content of the functionalized diene elastomer E2 in the composition of the invention is less than or equal to 40 phr, more preferentially is within a range extending from 30 phr to 50 phr, preferably from 30 phr to 45 phr, more preferentially from 35 phr to 45 phr.

These non-functional diene elastomers are commercially available from suppliers such as Nippon Zeon, JSR, Bayer, etc. or can be synthesized according to known processes.

### Reinforcing Filler

The rubber composition of the invention may comprise one or more reinforcing fillers capable of interacting with the diene elastomer E2.

Use may be made of any type of “reinforcing” filler known for its abilities to reinforce a rubber composition which can be used in particular in the manufacture of pneumatic tyres, for example an organic filler, such as carbon black, an inorganic filler, such as silica, or else a mixture of these two types of fillers.

The expression “reinforcing filler capable of interacting with the functionalized diene elastomer” is understood to mean any reinforcing filler, notably an inorganic filler such as silica for example, capable of forming, within a rubber composition, by means of a functionalized diene elastomer, a physical or chemical bond. This interaction may be established for example by means of covalent bonds, hydrogen bonds, ionic and/or electrostatic bonds between said functionalized elastomer and the functions present on the surface of the reinforcing fillers.

All carbon blacks, in particular the blacks conventionally used in pneumatic tyres or non-pneumatic tyres or their treads, are suitable as carbon blacks. Mention will more particularly be made, among the latter, of the reinforcing carbon blacks of the 200 series such as, for example, the N234 blacks. These carbon blacks can be used in the isolated state, as available commercially, or in any other form, for example as support for some of the rubber additives used. The carbon blacks might, for example, be already incorporated in the diene elastomer (see, for example, applications WO97/36724-A2 and WO99/16600-A1).

Mention may be made, as examples of organic fillers other than carbon blacks, of functionalized polyvinyl organic fillers, as described in applications WO2006/069792-A1, WO2006/069793-A1, WO2008/003434-A1 and WO2008/003435-A1.

Preferentially, the reinforcing filler capable of interacting with the diene elastomer E2 predominantly comprises at least one reinforcing inorganic filler, more preferentially still predominantly comprises at least one silica.

The term “reinforcing inorganic filler” should be understood here as meaning any inorganic or mineral filler, whatever its colour and its origin (natural or synthetic), also referred to as “white” filler, “clear” filler or even “non-black” filler, in contrast to carbon black, capable of reinforcing, by itself alone, without means other than an intermediate coupling agent, a rubber composition intended for the manufacture of pneumatic or non-pneumatic tyres. In a known way, some reinforcing inorganic fillers can be characterized in particular by the presence of hydroxyl (—OH) groups at their surface.

Mineral fillers of the siliceous type, preferentially silica (SiO₂), or of the aluminous type, especially alumina (Al₂O₃), are suitable in particular as reinforcing inorganic fillers.

The silica used can be any reinforcing silica known to those skilled in the art, in particular any precipitated or fumed silica exhibiting a BET specific surface area and a CTAB specific surface area both of less than 450 m²/g, preferably within a range extending from 30 to 400 m²/g, in particular from 60 to 300 m²/g. Any type of precipitated silica, in particular highly dispersible precipitated silicas (referred to as “HDS” for “highly dispersible” or “highly dispersible silica”), can be used. These precipitated silicas, which may or may not be highly dispersible, are well known to those skilled in the art. Mention may be made, for example, of the silicas described in applications WO03/016215-A1 and WO03/016387-A1. Use may in particular be made, among commercial HDS silicas, of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

The physical state in which the reinforcing inorganic filler is provided is not important, whether it is in the form of a powder, of micropearls, of granules, or else of beads or any other appropriate densified form. Of course, reinforcing inorganic filler is also understood to mean mixtures of different reinforcing inorganic fillers, in particular of silicas as described above.

According to a preferred embodiment of the invention, the reinforcing filler is predominantly an inorganic reinforcing filler (preferably silica), that is to say that it comprises more than 50% ( >50%) by weight of an inorganic reinforcing filler such as silica relative to the total weight of the reinforcing filler. Optionally according to this embodiment, the reinforcing filler can also comprise carbon black. According to this option, the carbon black is used at a content of less than or equal to 20 phr in the rubber composition, more preferentially less than or equal to 10 phr (for example the carbon black content may be within a range extending from 0.5 to 20 phr, in particular extending from 1 to 10 phr). Within the intervals indicated, the colouring properties (black pigmenting agent) and UV-stabilizing properties of the carbon blacks are beneficial, without, moreover, adversely affecting the typical performance qualities contributed by the reinforcing inorganic filler.

Those skilled in the art will understand that, as replacement for the reinforcing inorganic filler described above, use might be made of a reinforcing filler of another nature, provided that this reinforcing filler of another nature is covered with an inorganic layer, such as silica, or else comprises functional sites, in particular hydroxyl sites, at its surface which require the use of a coupling agent in order to establish the bond between this reinforcing filler and the diene elastomer.

Those skilled in the art will know how to adjust the total content of reinforcing filler depending on the use in question, in particular depending on the type of pneumatic tyres in question, for example for a passenger vehicle or else for a utility vehicle, such as a van or heavy-duty vehicle.

Preferably, the content of reinforcing filler in the rubber composition is within a range extending from 20 to 100 phr, more preferentially from 30 to 90 phr, and even more preferentially from 40 to 90 phr, the optimum being, in a known way, different depending on the specific applications targeted.

In the present account, the BET specific surface area is determined by gas adsorption using the Brunauer-Emmett-Teller method described in “The Journal of the American Chemical Society” (vol. 60, page 309, February 1938), and more specifically according to a method derived from Standard NF ISO 5794-1, Appendix E, of June 2010 [multipoint (5 point) volumetric method -gas: nitrogen - degassing under vacuum: one hour at 160° C. - relative pressure p/po range:: 0.05 to 0.17]. For the inorganic fillers, such as silica, for example, the CTAB specific surface area values were determined according to Standard NF ISO 5794-1, Appendix G, of June 2010. The process is based on the adsorption of CTAB (N-hexadecyl-N,N,N-trimethylammonium bromide) on the “external” surface of the reinforcing filler. For carbon blacks, the STSA specific surface is determined according to Standard ASTM D6556-2016.

Coupling agents for the inorganic reinforcing filler: As seen above, the reinforcing filler by itself is capable of interacting with the functionalized diene elastomer E2.

However, when the reinforcing filler is an inorganic filler, such as silica for example, it may be advantageous to increase the reinforcing power of this filler by using a coupling agent which makes it possible to couple the reinforcing inorganic filler to the diene elastomer.

In a well-known manner, use may be made of any at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound can comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of (symmetrical or asymmetrical) organosilane polysulfides, such as bis(3-triethoxysilylpropyl) tetrasulfide, abbreviated to TESPT, sold under the name Si69 by Evonik, or bis(3-triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl)propyl) octanethioate, sold by Momentive under the name NXT Silane. More preferentially, the organosilane is an organosilane polysulfide.

Of course, use might also be made of mixtures of the coupling agents described above.

The content of coupling agent in the rubber composition of the invention is advantageously less than or equal to 20 phr, it being understood that it is generally desirable to use as little as possible thereof. Typically, the content of coupling agent represents from 0.5% to 15% by weight, with respect to the amount of reinforcing inorganic filler. Its content is preferentially within a range extending from 0.5 to 20 phr. This content is easily adjusted by a person skilled in the art according to the content of reinforcing inorganic filler used in the composition of the invention.

### Covering Agents

The rubber compositions can also contain agents for covering the reinforcing inorganic filler when a reinforcing inorganic filler is used, making it possible to improve their processability in the uncured state. These covering agents are well known (see, for example, patent applications WO 2006/125533-A1, WO 2007/017060-A1 and WO 2007/003408-A1); mention will be made, for example, of hydrolysable silanes such as hydroxysilanes (see, for example, WO 2009/062733-A2), alkylalkoxysilanes, polyols (for example diols or triols), polyethers (for example polyethylene glycols), primary, secondary or tertiary amines, hydroxylated or hydrolysable polyorganosiloxanes (for example α,ω-dihydroxypolyorganosilanes (see, for example, EP 0784072-A1).

### Crosslinking System

The rubber compositions of the invention comprise at least one crosslinking system. The crosslinking system can be any type of system known to a person skilled in the art in the field of rubber compositions for pneumatic or non-pneumatic tyres. It may in particular be based on sulfur, and/or on peroxide and/or on bismaleimides.

Preferentially, the crosslinking system is based on sulfur; it is then called a vulcanization system. The sulfur can be provided in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or equivalent compound, such as stearic acid salts, and salts of transition metals, guanidine derivatives (in particular diphenylguanidine), or else known vulcanization retarders.

The sulfur is used at a preferential content in a range extending from 0.5 to 12 phr, more preferentially in a range extending from 0.7 to 10 phr. The vulcanization accelerator is used at a preferential content in a range extending from 0.5 to 10 phr, more preferentially in a range extending from 0.5 to 5.0 phr.

Use may be made, as accelerator, of any compound capable of acting as accelerator of the vulcanization of diene elastomers in the presence of sulfur, in particular accelerators of the thiazole type, and also their derivatives, or accelerators of sulfenamide, thiuram, dithiocarbamate, dithiophosphate, thiourea and xanthate types.

### Plasticizers

The rubber composition according to the invention may comprise at least one plasticizer.

As is known to those skilled in the art of rubber compositions for pneumatic or non-pneumatic tyres, this plasticizer is preferably chosen from hydrocarbon resins with a high glass transition temperature (Tg), low-Tg hydrocarbon resins, plasticizing oils and mixtures thereof. Preferably, the plasticizer is chosen from high-Tg hydrocarbon resins,plasticizing oils and mixtures thereof.

As is known, the plasticizers in the rubber compositions make it possible to modify the viscosity of a rubber composition, to adjust the glass transition temperature of the rubber composition with respect to its optimum use.

A high-Tg hydrocarbon resin is by definition a solid at ambient temperature and pressure (20° C., 1 atm), while a plasticizing oil is liquid at ambient temperature and pressure and a low-Tg hydrocarbon resin is viscous at ambient temperature and pressure.

Hydrocarbon resins, also known as hydrocarbon plasticizing resins, are polymers well known to a person skilled in the art, essentially based on carbon and hydrogen but which can comprise other types of atoms, for example oxygen, which can be used in particular as plasticizing agents. They are by nature at least partially miscible (i.e. compatible) at the contents used with the rubber compositions for which they are intended, so as to act as true diluents. They have been described, for example, in the book entitled “Hydrocarbon Resins” by R. Mildenberg, M. Zander and G. Collin (New York, VCH, 1997, ISBN 3-527-28617-9), Chapter 5 of which is devoted to their applications, notably in the pneumatic tyre rubber field (5.5. “Rubber Tires and Mechanical Goods”). In a known way, these hydrocarbon resins can also be described as thermoplastic resins in the sense that they soften when heated and can thus be moulded. The softening point of the hydrocarbon resins is measured according to standard ISO 4625 (“Ring and Ball” method). The Tg is measured according to standard ASTM D3418 (2008). The macrostructure (Mw, Mn and PI) of the hydrocarbon resin is determined by size exclusion chromatography (SEC); solvent tetrahydrofuran; temperature 35° C.; concentration 1 g/l; flow rate 1 ml/min; solution filtered through a filter with a porosity of 0.45 µm before injection; Moore calibration with polystyrene standards; set of 3 Waters columns in series (Styragel HR4E, HR1 and HR0.5); detection by differential refractometer (Waters 2410) and its associated operating software (Waters Empower). The hydrocarbon resins can be aliphatic or aromatic or also of the aliphatic/aromatic type, that is to say based on aliphatic and/or aromatic monomers. They can be natural or synthetic and may or may not be petroleum-based (if such is the case, they are also known under the name of petroleum resins). In a known way, the high-Tg hydrocarbon resins are thermoplastic hydrocarbon resins, the Tg of which is above 20° C.

Preferably, the plasticizer can optionally comprise a hydrocarbon resin, which is solid at ambient temperature and pressure, referred to as a high-Tg resin. Preferably, the high-Tg hydrocarbon plasticizing resin exhibits at least any one of the following characteristics:
a Tg above 30° C.;
a number-average molecular weight (Mn) of between 300 and 2000 g/mol, more preferentially between 400 and 1500 g/mol;
a polydispersity index (PI) of less than 3, more preferentially less than 2 (reminder: PI = Mw/Mn, with Mw the weight-average molecular weight).

More preferentially, this high-Tg hydrocarbon plasticizing resin exhibits all of the preferential characteristics above.

The plasticizer may optionally comprise a hydrocarbon resin which is viscous at 20° C., referred to as “low-Tg” resin, that is to say which, by definition, has a Tg within a range extending from -40° C. to 20° C.

Preferably, the low-Tg hydrocarbon plasticizing resin exhibits at least any one of the following characteristics:
a Tg of between -40° C. and 0° C., more preferentially between -30° C. and 0° C. and more preferentially still between -20° C. and 0° C.;
a number-average molecular weight (Mn) of less than 800 g/mol, preferably of less than 600 g/mol and more preferentially of less than 400 g/mol;
a softening point within a range extending from 0° C. to 50° C., preferentially from 0° C. to 40° C., more preferentially from 10° C. to 40° C., preferably from 10° C. to 30° C.;
a polydispersity index (PI) of less than 3, more preferentially less than 2 (reminder: PI = Mw/Mn, with Mw the weight-average molecular weight).

More preferentially, this low-Tg hydrocarbon resin exhibits all of the preferential characteristics above.

The plasticizer can also contain an extender oil (or plasticizing oil) which is liquid at 20° C., referred to as “low-Tg” plasticizer, that is to say which by definition has a Tg below -20° C., preferably below -40° C. Any extender oil, whether it is of aromatic or non-aromatic nature, known for its plasticizing properties with regard to elastomers can be used. At ambient temperature (20° C.), these oils, which are more or less viscous, are liquids (that is to say, as a reminder, substances which have the ability to eventually assume the shape of their container), unlike in particular high-Tg hydrocarbon resins, which are by nature solids at ambient temperature. Plasticizing oils selected from the group consisting of naphthenic oils (low- or high-viscosity, in particular hydrogenated or non-hydrogenated), paraffinic oils, MES (Medium Extracted Solvate) oils, TDAE (Treated Distillate Aromatic Extract) oils, RAE (Residual Aromatic Extract) oils, TRAE (Treated Residual Aromatic Extract) oils and SRAE (Safety Residual Aromatic Extract) oils, mineral oils, plant oils, ether plasticizers, ester plasticizers, phosphate plasticizers, sulfonate plasticizers and the mixtures of these compounds are particularly suitable.

The high-Tg hydrocarbon resins, the low-Tg hydrocarbon resins, and the preferential plasticizing oils above are well known to those skilled in the art and commercially available.

### Other Additives

The rubber compositions in accordance with the invention can also comprise all or part of the usual additives and processing aids known to a person skilled in the art and generally used in rubber compositions for pneumatic or non-pneumatic tyres, in particular for treads, such as, for example, fillers (reinforcing or non-reinforcing / other than those mentioned above), pigments, protective agents, such as antiozone waxes, chemical antiozonants or antioxidants, anti-fatigue agents or reinforcing resins (such as described, for example, in application WO 02/10269).

### Obtaining the Rubber Compositions According to the Invention

The rubber composition can be obtained by the customary processes for manufacturing rubber compositions, such as dry mixing of the various ingredients.

According to one embodiment, the rubber composition in accordance with the invention is manufactured in appropriate mixers using two successive preparation phases well known to a person skilled in the art:
a first phase of thermomechanical working or kneading (“non-productive” phase), which can be carried out in a single thermomechanical step during which, in the following sequential order, the functionalized diene elastomer E2 having a glass transition temperature TgE2, the reinforcing filler and optionally the coupling agent for the reinforcing filler are introduced into an appropriate mixer, such as a standard internal mixer (for example of “Banbury” type). After thermomechanical kneading, during which these ingredients are maintained at a temperature within a range extending from 140° C. to 200° C. for one to two minutes, the non-functionalize diene elastomer E1 having a glass transition temperature TgE1, and also all the necessary constituents, with the exception of the crosslinking system, are introduced into the internal mixer. These ingredients undergo thermomechanical kneading for 2 to 10 minutes up to a maximum temperature within a range extending from 110° C. to 200° C., preferably extending from 130° C. to 185° C. (and referred to as the “dropping temperature”);
a second phase of mechanical working (“productive” phase) is carried out in an external mixer, such as an open mill, after cooling the mixture obtained during the non-productive first phase down to a lower temperature, typically below 120° C., for example in a range extending from 40° C. to 100° C. The crosslinking system is then incorporated by mixing for 5 to 15 min, in order to obtain the rubber compound of the invention.

According to another preferred embodiment of the invention, the rubber composition of the invention is prepared in the form of two masterbatches, then the masterbatches are mixed so as to obtain the rubber composition according to the invention.

More specifically, according to this embodiment, a first masterbatch is prepared by mixing, in a suitable mixer such as a standard internal mixer (for example of “Banbury” type), said non-functionalized diene elastomer E1 and the other optional constituents such as plasticizer(s), antiozonants, etc., with the exception of the vulcanization system. Thermomechanical working is carried out for 2 to 10 minutes up to a maximum temperature within a range extending from 110° C. to 200° C., preferably extending from 130° C. to 185° C. (and referred to as the “dropping temperature”). The first masterbatch comprising at least the non-functionalized diene elastomer E1 is thus recovered.

Next, a second masterbatch is prepared by mixing, in a suitable mixer such as a standard internal mixer (for example of “Banbury” type), said functionalized diene elastomer E2, the reinforcing filler and the other optional constituents such as the coupling agent for the reinforcing filler and/or plasticizer(s), antiozonants, etc., with the exception of the vulcanization system. Thermomechanical working is carried out for a time of 2 to 10 minutes up to a maximum temperature within a range extending from 140° C. to 200° C., preferably extending from 140° C. to 185° C. (and referred to as the “dropping temperature”). The second masterbatch comprising at least the functionalized diene elastomer E2 and the reinforcing filler capable of interacting with the functionalized diene elastomer E2 is thus recovered.

The two masterbatches from the preceding steps are introduced into a standard internal mixer (for example of “Banbury” type) and Thermo mechanical working is carried out for 2 to 10 minutes up to a maximum temperature within a range extending from 110° C. to 180° C., preferably extending from 130° C. to 180° C. (and referred to as the “dropping temperature”).

The mixture from the preceding step is then cooled on an external mixer such as an open mill down to a temperature below or equal to 110° C. The crosslinking system is then incorporated by mixing for 5 to 15 min, and the rubber composition is recovered.

Irrespective of the method of preparing the rubber composition, the final composition thus obtained is subsequently calendered, for example in the form of a sheet or slab, notably for laboratory characterization, or else extruded in the form of a rubber semi-finished product (or profiled element) which can be used, for example, as a tread in a pneumatic or non-pneumatic tyre, in particular for a passenger vehicle.

The composition may be either in the uncured state (before crosslinking or vulcanization) or in the cured state (after crosslinking or vulcanization), and may be a semi-finished product which can be used in a pneumatic or non-pneumatic tyre.

The crosslinking of the rubber composition can be carried out in a manner known to those skilled in the art, for example at a temperature within a range extending from 130° C. to 200° C., under pressure.

### Other Subjects of the Invention

Another subject of the present invention relates to a tread comprising at least one composition defined above. The rubber composition according to the invention can constitute the whole tread or else part of the tread.

Another subject of the present invention relates to a pneumatic or non-pneumatic tyre comprising at least one composition defined above or comprising a tread defined above.

A “pneumatic tyre” is understood to mean a tyre intended to form a cavity by cooperating with a support element, for example a rim, this cavity being able to be pressurized to a pressure higher than atmospheric pressure. In contrast, a “non-pneumatic tyre” is not able to be pressurized. Thus, a non-pneumatic tyre is a toric body made up of at least one polymer material, intended to perform the function of a tyre but without being subjected to an inflation pressure. A non-pneumatic tyre may be solid or hollow. A hollow non-pneumatic tyre may contain air, but at atmospheric pressure, which is to say that it has no pneumatic stiffness afforded by an inflation gas at a pressure higher than atmospheric pressure.

The pneumatic tyres according to the invention are intended to be fitted to vehicles of any type such as passenger vehicles, two-wheeled vehicles, heavy-duty vehicles, agricultural vehicles, construction plant vehicles or aircraft or, more generally, on any rolling device. The non-pneumatic tires are intended to be fitted in particular to passenger vehicles or two-wheeled vehicles. Preferably, the pneumatic tyres according to the invention are intended to be fitted to passenger vehicles.

Preferentially, the pneumatic or non-pneumatic tyre comprises at least one tread comprising at least one rubber composition defined above.

### MEASUREMENT METHODS

### Determination of the Glass Transition Temperature of the Elastomers

The glass transition temperatures (Tg) of the elastomers, before their use, are determined using a differential scanning calorimeter according to standard ASTM D3418:2008.

### Determination of the Μₘₐₓ Coefficient of Dynamic friction

The measurements of the coefficient of dynamic friction were carried out according to a method identical to that described by L. Busse, A. Le Gal, and M. Küppel (Modelling of Dry and Wet Friction of Silica Filled Elastomers on Self-Affine Road Surfaces, Elastomer Friction, 2010, 51, p. 8). The test specimens were produced by moulding, then crosslinking of a square rubbery support (50 mm × 50 mm) having a thickness of 6 mm. After closing the mould, the latter is placed in a press with heated platens at the temperature of 150° C., and for the time necessary for the crosslinking of the material (typically several tens of minutes), at a pressure of 16 bar. The surface used to carry out these measurements is a core withdrawn from a real road surface made of bituminous concrete of BBTM [very thin bituminous concrete] type (standard NF P 98-137). In order to prevent the phenomena of dewetting and the appearance of secondary grip forces between the ground and the material, the ground + test specimen system is immersed in a 5% aqueous solution of a surfactant (Sinnozon - CAS number: 25155-30-0). The temperature of the aqueous solution is regulated using a thermostatic bath. The test specimen is subjected to a sliding movement in translation parallel to the plane of the ground. The sliding velocity SV is set at 1.2 m/s. The normal stress applied σₙ is 400 kPa (i.e. 4 bar). These conditions are described below by “wet ground conditions”. The tangential stress σₜ, opposed to the movement of the test specimen over the ground, is measured continuously. The ratio of the tangential stress σₜ to the normal stress σₙ gives the coefficient of dynamic friction µ. The coefficient of dynamic friction values are measured during a temperature sweep of the aqueous solution, ranging from 3° C. to 44° C., are obtained in steady state after stabilization of the value of the tangential stress σₜ.

In the examples, the maximum value of the coefficient of dynamic friction (denoted µₘₐₓ) measured during this sweep is indicated.

Unless otherwise indicated, the results are given in base 100. The arbitrary value 100 being assigned to the comparative composition in order to calculate and then compare the maximum coefficient of dynamic friction of the various samples tested. The value in base 100 for the sample to be tested is calculated according to the operation: (µₘₐₓ value of the sample to be tested / µₘₐₓ value of the comparative composition) × 100. In this way, a result less than 100 will indicate a decrease in the maximum coefficient of dynamic friction and therefore a drop in the wet grip performance. Conversely, a result greater than 100 will indicate an increase in the maximum coefficient of dynamic friction and therefore an increase in the wet grip performance.

### Measurement of the Dynamic Properties After Curing

The dynamic properties tan(δ)max are measured on a viscosity analyser (Metravib A4000) according to Standard ASTM D 5992-96. The response of a sample of vulcanized composition (2 cylindrical test specimens with a thickness of 2 mm and with a cross section of 78.5 mm²), subjected to a simple alternating sinusoidal shear stress, at a frequency of 10 Hz, at a temperature of 40° C., is recorded. A peak-to-peak strain amplitude sweep is carried out from 1% to 100% (forward cycle) and then from 100% to 1% (return cycle). The results made use of are the loss factor tan(δ). For the return cycle, the maximum value of tan(δ) observed (tan (δ)max), denoted by tan(δ)ₘₐₓ ₐₜ _{40°C} is indicated.

The results are expressed in terms of performance in base 100, that is to say that the value 100 is arbitrarily assigned to the comparative composition, in order to calculate and subsequently compare the tan δₘₐₓ ₐₜ _{40°C} of the various rubber compositions tested. The value in base 100 is calculated according to the operation: (value of tan δₘₐₓ ₐₜ _{40°C} of the comparative composition/value of tan δₘₐₓ _{at 40°C} of the sample)* 100. In this way, a lower value represents a decrease in the hysteresis properties whereas a higher value represents an improvement in the hysteresis properties.

### EXAMPLES

### 1- Ingredients

The ingredients used in the examples are the following:

Elastomer (1A): Non-functionalized styrene/butadiene copolymer having a Tg of -28° C. measured according to standard ASTM D3418:2008, a styrene content of 41% by weight relative to the total weight of the copolymer, a vinyl-1,2 butadiene content of 14% by weight relative to the total weight of the copolymer, a trans-1,4 butadiene content of 27% by weight relative to the total weight of the copolymer.

Elastomer (1B): Styrene/butadiene copolymer bearing a silanol function at the end of the elastomer chain, and having a Tg of -24° C. measured according to standard ASTM D3418:2008, a styrene content of 25% by weight relative to the total weight of the copolymer, a vinyl-1,2 butadiene content of 43% by weight relative to the total weight of the copolymer, a trans-1,4 butadiene content of 16% by weight relative to the total weight of the copolymer.

Elastomer (1C): Styrene/butadiene copolymer having a Tg of -65° C. measured according to standard ASTM D3418:2008, a styrene content of 16% by weight relative to the total weight of the copolymer, a vinyl-1,2 butadiene content of 20% by weight relative to the total weight of the copolymer, a trans-1,4 butadiene content of 39% by weight relative to the total weight of the copolymer.

Elastomer (1D): Styrene/butadiene copolymer bearing an aminoalkoxysilane function in the middle of the chain and having a Tg of -65° C. measured according to standard ASTM D3418:2008, a styrene content of 16% by weight relative to the total weight of the copolymer, a vinyl-1,2 butadiene content of 20% by weight relative to the total weight of the copolymer, a trans-1,4 butadiene content of 39% by weight relative to the total weight of the copolymer.

Elastomer (1F): Styrene/butadiene copolymer bearing an aminoalkoxysilane function in the middle of the chain and having a Tg of -48° C. measured according to standard ASTM D3418:2008, a styrene content of 27% by weight relative to the total weight of the copolymer, a vinyl-1,2 butadiene content of 17.5% by weight relative to the total weight of the copolymer, a trans-1,4 butadiene content of 33.5% by weight relative to the total weight of the copolymer.

Elastomer (1G): Non-functionalized styrene/butadiene copolymer having a Tg of -48° C. measured according to standard ASTM D3418:2008, a styrene content of 27% by weight relative to the total weight of the copolymer, a vinyl-1,2 butadiene content of 17.5% by weight relative to the total weight of the copolymer, a 1,4 butadiene content of 33.5% by weight relative to the total weight of the copolymer.

Carbon black (2): ASTM grade N234 carbon black sold by Cabot Corporation.

Silica : Zeosil 1165MP silica sold by Solvay.

Silane : Bis[3-(triethoxysilyl)propyl] tetrasulfide (TESPT) silane, sold by Evonik under the reference Si69;

DPG : Diphenylguanidine, Perkacit DPG from Flexsys.

Plasticizer (6): DCPD resin having a softening point of 100° C., a glass transition temperature of 51° C. sold under the reference PR-383 by Exxon Mobil.

Antiozone wax (7): Varazon 4959 antiozone wax from Sasol Wax

Antioxidant (8): N-(1,3-dimethylbutyl)-N-phenyl-para-phenylenediamine sold by Flexsys under the reference Santoflex 6-PPD.

ZnO : Zinc oxide (industrial grade), sold by Umicore.

Stearic acid (10): Pristerene 4031 stearin sold by Uniqema.

### 2. Test 1: Impact of the Location of Reinforcing Fillers in the Rubber Composition

The examples presented in Table 1 are intended to compare the various rubber properties of the rubber composition CI1 in accordance with the invention with a series of comparative rubber compositions CC1 and CC2.

Table 1 presents the formulation of these rubber compositions; the proportions are expressed in phr, that is to say in parts by weight per 100 parts by weight of the elastomers of the composition.

TABLE 1

| | CC1 | CC2 | CI1 |
|---|---|---|---|
| Elastomer (1A) | 50.0 | 0.0 | 60.0 |
| Elastomer (1B) | 0.0 | 40.0 | 0.0 |
| Elastomer (1C) | 50.0 | 60.0 | 0.0 |
| Elastomer (1D) | 0.0 | 0.0 | 40.0 |
| Black (2) | 3.8 | 3.8 | 3.8 |
| Silica (3) | 55.0 | 55.0 | 55.0 |
| Silane (4) | 4.4 | 4.4 | 4.4 |
| DPG (5) | 1.2 | 1.2 | 1.2 |
| Plasticizer (6) | 16.0 | 16.0 | 16.0 |
| Antiozone wax (7) | 2.0 | 2.0 | 2.0 |
| Antioxidant (8) | 1.0 | 1.0 | 1.0 |
| ZnO (9) | 2.5 | 2.5 | 2.5 |
| Stearic acid (10) | 2.0 | 2.0 | 2.0 |
| Sulfur | 1.8 | 1.8 | 1.8 |
| CBS | 2.2 | 2.2 | 2.2 |

The comparative rubber composition CC1 is obtained from two masterbatches, masterbatch 1 and masterbatch 2, obtained by dry mixing according to the following process:

All the ingredients from Table 2 are introduced, in one or more stages, into a 414 cm³ Polylab internal mixer, filled to 70% by volume and the initial vessel temperature of which is 90° C. Thermomechanical working is carried out for 6 minutes until a maximum dropping temperature of 165° C. is reached. The mixture thus obtained, referred to as masterbatch 1, is recovered.

All the ingredients from Table 3 are introduced, in one or more stages, into another 414 cm³ Polylab internal mixer, filled to 70% by volume and the initial vessel temperature of which is 90° C. Thermomechanical working is carried out for 6 minutes until a maximum dropping temperature of 165° C. is reached. The mixture thus obtained, referred to as masterbatch 2, is recovered.

The masterbatch 1 and masterbatch 2 obtained previously are then introduced into a 414 cm³ Polylab internal mixer, filled to 70% by volume and thermomechanical working is carried out for 5 minutes until a maximum dropping temperature of 150° C. is reached.

The mixture from the previous step is then introduced into an external mixer, such as an open mill, so as to cool this mixture to a temperature of 40° C. The crosslinking system (1.8 phr of sulfur and 2.2 phr of CBS (N-cyclohexyl-2-benzothiazolesulfenamide sold by Flexsys under the reference Santocure CBS)) is then incorporated and mixed for 20 min. The rubber composition thus obtained is then calendered in the form of slabs in order to carry out measurements of its physical or mechanical properties. Unless otherwise indicated, the rubber properties of the rubber composition are measured after curing at 170° C. for 20 min.

TABLE 2

| | | |
|---|---|---|
| Masterbatch 1-CC1 | Elastomer (1A) | 50.0 |
| | Black (2) | 1.9 |
| | Silica (3) | 27.5 |
| | Silane (4) | 2.2 |
| | DPG (5) | 0.6 |
| | Plasticizer (6) | 8.0 |
| | Antiozone wax (7) | 1.0 |
| | Antioxidant (8) | 0.5 |
| | ZnO (9) | 1.3 |
| | Stearic acid (10) | 1.00 |

TABLE 3

| | | |
|---|---|---|
| Masterbatch 2-CC1 | Elastomer (1C) | 50.0 |
| | Black (2) | 1.9 |
| | Silica (3) | 27.5 |
| | Silane (4) | 2.2 |
| | DPG (5) | 0.6 |
| | Plasticizer (6) | 8.0 |
| | Antiozone wax (7) | 1.0 |
| | Antioxidant (8) | 0.5 |
| | ZnO (9) | 1.2 |
| | Stearic acid (10) | 1.0 |

The comparative rubber composition CC2 and the rubber composition of the invention CI1 are prepared according to the process described for the rubber composition CC1, with respectively the masterbatches 1 and 2 from Tables 4 and 5 for the comparative composition CC2 and the masterbatches 1 and 2 from tables 6 and 7 for the rubber composition of the invention CI1.

TABLE 4

| Masterbatch 1-CC2 | Elastomer (1B) | 40.0 |
|---|---|---|
| | Black (2) | 3.8 |
| | Silica (3) | 39.7 |
| | Silane (4) | 3.2 |
| | DPG (5) | 0.6 |
| | Plasticizer (6) | 9.4 |
| | Antiozone wax (7) | 1.0 |
| | Antioxidant (8) | 0.5 |
| | ZnO (9) | 1.0 |
| | Stearic acid (10) | 0.8 |

TABLE 5

| | | |
|---|---|---|
| Masterbatch 2-CC2 | Elastomer (1C) | 60.0 |
| | Black (2) | 0.0 |
| | Silica (3) | 15.3 |
| | Silane (4) | 1.2 |
| | DPG (5) | 0.6 |
| | Plasticizer (6) | 6.6 |
| | Antiozone wax (7) | 1.0 |
| | Antioxidant (8) | 0.5 |
| | ZnO (9) | 1.5 |
| | Stearic acid (10) | 1.2 |

TABLE 6

| | | |
|---|---|---|
| Masterbatch 1-CI1 | Elastomer (1A) | 60.0 |
| | Black (2) | 0.0 |
| | Silica (3) | 15.3 |
| | Silane (4) | 1.2 |
| | DPG (5) | 0.6 |
| | Plasticizer (6) | 6.6 |
| | Antiozone wax (7) | 1.0 |
| | Antioxidant (8) | 0.5 |
| | ZnO (9) | 1.5 |
| | Stearic acid (10) | 1.2 |

TABLE 7

| | | |
|---|---|---|
| Masterbatch 2-CI1 | Elastomer (1D) | 40.0 |
| | Black (2) | 3.8 |
| | Silica (3) | 39.7 |
| | Silane (4) | 3.2 |
| | DPG (5) | 0.6 |
| | Plasticizer (6) | 9.4 |
| | Antiozone wax (7) | 1.0 |
| | Antioxidant (8) | 0.5 |
| | ZnO (9) | 1.0 |
| | Stearic acid (10) | 0.8 |

The rubber properties of the rubber compositions CC1, CC2 and CI1, measured after curing, are presented in Table 8.

TABLE 8

| | | CC1 | CC2 | CI1 |
|---|---|---|---|---|
| Glass transition temperature of the elastomers (measured in °C) | TgE1 | -28° C. | -24° C. | -28° C. |
| | TgE2 | -65° C. | -65° C. | -65° C. |
| Tan δₘₐₓ ₐₜ _{40°C}(in base 100) | | 100 | 98 | 116 |

µₘₐₓ (in base 100) 100 86 105

Despite having the same amount of reinforcing fillers (58.80 phr), the rubber composition of the invention CI1 differs from the comparative rubber compositions CC1 and CC2 in that the reinforcing fillers, in particular the silica, interact with the elastomer having the lowest glass transition temperature, i.e. with the elastomer having the glass transition temperature TgE2. The rubber composition CC1 comprising no functionalized elastomer has a homogeneous distribution of the reinforcing fillers between the two elastomers of different glass transition temperature. In the rubber composition CC2, the reinforcing fillers interact with the functionalized elastomer having the highest glass transition temperature, i.e. with the elastomer having the glass transition temperature TgE1.

Compared to the comparative rubber composition CC1 which has a homogeneous distribution of the reinforcing filler in the elastomer matrix, the rubber composition CC2 has, for equivalent hysteresis properties (tan δₘₐₓ ₐₜ _{40°C}), a significant reduction in the coefficient µₘₐₓ, and therefore a reduction in the wet grip performance. Thus, when the reinforcing fillers interact with the elastomer having the highest glass transition temperature, in this case TgE1 for the rubber composition CC2, a degradation of the wet grip performance is therefore observed for hysteresis properties equivalent to the comparative rubber composition CC1.

Surprisingly, when the reinforcing fillers interact with the elastomer having the lowest Tg (in this case the functionalized elastomer having a glass transition temperature TgE2, see the rubber composition according to the invention CI1), a significant improvement in the hysteresis properties and also an increase in the coefficient µₘₐₓ, and therefore an improvement in the wet grip performance, are observed compared to the comparative rubber composition CC1. This result is surprising since the improvement in the hysteresis properties is not achieved at the expense of the wet grip performance.

### 3. Test 2: Impact of the Difference in Glass Transition Temperature of the Elastomers Forming the Rubber Composition

The examples presented in Table 9 are intended to compare the various rubber properties of the rubber composition CI1 in accordance with the invention with respect to two comparative rubber compositions CC3 and CC4.

Table 9 shows the formulation of the rubber compositions tested, the proportions are expressed in phr, that is to say in parts by weight per 100 parts by weight of the elastomers of the composition.

TABLE 9

| | CC3 | CC4 | CC1 |
|---|---|---|---|
| Elastomer (1A) | 60.0 | 0.0 | 60.0 |
| Elastomer (1D) | 0.0 | 40.0 | 40.0 |
| Elastomer (1F) | 40.0 | 0.0 | 0.0 |
| Elastomer (1G) | 0.0 | 60.0 | 0.0 |
| Black (2) | 3.8 | 3.8 | 3.8 |
| Silica (3) | 55.0 | 55.0 | 55.0 |
| Silane (4) | 4.4 | 4.4 | 4.4 |
| DPG (5) | 1.2 | 1.2 | 1.2 |
| Plasticizer (6) | 16.0 | 16.0 | 16.0 |
| Antiozone wax (7) | 2.0 | 2.0 | 2.0 |
| Antioxidant (8) | 1.0 | 1.0 | 1.0 |
| ZnO (9) | 2.5 | 2.5 | 2.5 |
| Stearic acid (10) | 2.0 | 2.0 | 2.0 |
| Sulfur | 1.8 | 1.8 | 1.8 |
| CBS | 2.2 | 2.2 | 2.2 |

The rubber composition CC3 and the rubber composition CC4 are prepared according to the process of test 1 with, respectively, the masterbatches of Table 6 (masterbatch 1-CI1) and of Table 10 (masterbatch 2-CC3) for the rubber composition CC3 and the masterbatches of Table 11 (masterbatch 1-CC4) and of Table 7 (masterbatch 2-CC1) for the rubber composition CC4.

TABLE 10

| | | |
|---|---|---|
| Masterbatch 2-CC3 | Elastomer (1F) | 40.0 |
| | Black (2) | 3.8 |
| | Silica (3) | 39.7 |
| | Silane (4) | 3.2 |
| | DPG (5) | 0.6 |
| | Plasticizer (6) | 9.4 |
| | Antiozone wax (7) | 1.0 |
| | Antioxidant (8) | 0.5 |
| | ZnO (9) | 1.0 |
| | Stearic acid (10) | 0.8 |

TABLE 11

| | | |
|---|---|---|
| Masterbatch 1-CC4 | Elastomer (1G) | 60.0 |
| | Black (2) | 0.0 |
| | Silica (3) | 15.3 |
| | Silane (4) | 1.2 |
| | DPG (5) | 0.6 |
| | Plasticizer (6) | 6.6 |
| | Antiozone wax (7) | 1.0 |
| | Antioxidant (8) | 0.5 |
| | ZnO (9) | 1.5 |
| | Stearic acid (10) | 1.2 |

The rubber properties of these compositions, measured after curing, are presented in Tables 12 and 13.

TABLE 12

| | | CC3 | CI1 |
|---|---|---|---|
| Glass transition temperature of the elastomers (measured in °C) | TgE1 | -28° C. | -28° C. |
| | TgE2 | -48° C. | -65° C. |
| Tan δ_{max at 40°C} (in base 100) | | 100 | 117 |

µₘₐₓ (in base 100) 100 100

The rubber composition according to the invention CI1 differs from the comparative rubber composition CC3 in the elastomer of lower glass transition temperature (i.e. the elastomer with glass transition temperature TgE2).

When the formulation of the comparative composition CC3 is modified so that the difference in glass transition temperature of the elastomers is greater than or equal to 23° C., the rubber composition according to the invention CI1 is obtained, then it is found that the hysteresis properties are significantly improved for the rubber composition of the invention CI1 compared to the comparative composition CC3.

Surprisingly, this improvement in the hysteresis properties of the rubber composition of the invention CI1 is not achieved at the expense of the coefficient µₘₐₓ, and therefore of the wet grip performance.

TABLE 13

| | | CC4 | CI1 |
|---|---|---|---|
| Glass transition temperature of the elastomers (measured in °C) | TgE1 | -48° C. | -28° C. |
| | TgE2 | -65° C. | -65° C. |
| Tan δ_{max at 40°C} (in base 100) | | 100 | 98 |

µₘₐₓ (in base 100) 100 119

The rubber composition according to the invention CI1 differs from the comparative rubber composition CC4 in the elastomer of higher glass transition temperature (i.e. the elastomer with glass transition temperature TgE1).

When the formulation of the comparative composition CC4 is modified so that the difference in glass transition temperature of the elastomers is greater than or equal to 23° C., the rubber composition according to the invention CI1 is obtained, then it is found that the coefficient µₘₐₓ is significantly improved compared to the comparative composition CC4. The rubber composition of the invention therefore has a wet grip performance superior to that of the comparative rubber composition CC4. Surprisingly, the improvement in the wet grip performance is not achieved at the expense of the hysteresis properties, which are equivalent to those of the comparative rubber composition CC4.

### 4. Test 3: Comparison With Prior Art

The examples presented in Table 14 are intended to compare the various rubber properties of the rubber composition CI1 in accordance with the invention with respect to a comparative rubber composition CC5 representative of Example 4 from document EP3372638A1.

The formulation of the rubber composition CC5 is presented in Table 14, the proportions are expressed in phr.

TABLE 14

| | CC5 | CI1 |
|---|---|---|
| Elastomer (1F) | 50.0 | 0.0 |
| Elastomer (1D) | 50.0 | 40.0 |
| Elastomer (1A) | 0.0 | 60.0 |
| Black (2) | 3.8 | 3.8 |
| Silica (3) | 55.0 | 55.0 |
| Silane (4) | 4.4 | 4.4 |
| DPG (5) | 1.2 | 1.2 |
| Plasticizer (6) | 16.0 | 16.0 |
| Antiozone wax (7) | 2.0 | 2.0 |
| Antioxidant (8) | 1.0 | 1.0 |
| ZnO (9) | 2.5 | 2.5 |
| Stearic acid (10) | 2.0 | 2.0 |
| Sulfur | 1.8 | 1.8 |

The rubber composition CC5 is prepared according to the process of test 1 with the masterbatches from Tables 15 and 16 respectively.

TABLE 15

| | | |
|---|---|---|
| Masterbatch 1-CC5 | Elastomer (1F) | 50.0 |
| | Black (2) | 1.9 |
| | Silica (3) | 0.0 |
| | Silane (4) | 0.0 |
| | DPG (5) | 0.6 |
| | Plasticizer (6) | 0.0 |
| | Antiozone wax (7) | 1.0 |
| | Antioxidant (8) | 0.5 |
| | ZnO (9) | 1.3 |
| | Stearic acid (10) | 1.0 |

TABLE 16

| | | |
|---|---|---|
| Masterbatch 2-CC5 | Elastomer (1D) | 50.0 |
| | Black (2) | 1.9 |
| | Silica (3) | 55.0 |
| | Silane (4) | 4.4 |
| | DPG (5) | 0.6 |
| | Plasticizer (6) | 16.0 |
| | Antiozone wax (7) | 1.0 |
| | Antioxidant (8) | 0.5 |
| | ZnO (9) | 1.2 |
| | Stearic acid (10) | 1.0 |

The rubber properties of the rubber compositions, measured after curing, are presented in Table 17.

TABLE 17

| | | CC5 | CI1 |
|---|---|---|---|
| Glass transition temperature of the elastomers (measured in °C) | TgE1 | -48° C. | -28° C. |
| | TgE2 | -65° C. | -65° C. |
| Tan δₘₐₓ ₐₜ _{40°C} (in base 100) | | 100 | 99 |

µₘₐₓ (in base 100) 100 127

It is observed that the rubber composition according to the invention CI1 has a significantly improved coefficient µₘₐₓ compared to the rubber composition CC5 representative of the prior art. This result indicates that the wet grip of the rubber composition according to the invention CI1 is significantly better than the wet grip of the rubber composition CC5. Surprisingly, this significant improvement in coefficient µₘₐₓ is not achieved at the expense of the hysteresis properties since the two rubber compositions have the same values of δ_{max at 40°C}.

All of the above tests presented show that the rubber composition according to the invention MI1 has a significant improvement in the hysteresis properties, therefore a decrease in the rolling resistance, while retaining a very good wet grip performance compared to the comparative rubber compositions.

1-16. (canceled)

17. A rubber composition based on at least one non-functionalized first diene elastomer E1 having a glass transition temperature TgE1, one functionalized second diene elastomer E2 having a glass transition temperature TgE2, a reinforcing filler capable of interacting with the functionalized diene elastomer E2 and a crosslinking system,
wherein the glass transition temperature TgE1 is above or equal to -50° C.,
wherein the glass transition temperature TgE2 satisfies the mathematical relationship TgE2 ≤ TgE1-23° C., and
wherein a content of the non-functionalized diene elastomer E1 is greater than or equal to 50 phr.

18. The rubber composition according to claim 17, wherein the glass transition temperature TgE2 satisfies the mathematical relationship TgE2 ≤ TgE1-28° C.

19. The rubber composition according to claim 17, wherein the glass transition temperature TgE2 satisfies the mathematical relationship TgE2 ≥ TgE1-65° C.

20. The rubber composition according to claim 17, wherein the glass transition temperature TgE2 is within a range extending from -110° C. to -23° C.

21. The rubber composition according to claim 17, wherein the functionalized diene elastomer E2 is selected from the group consisting of natural rubber, synthetic polyisoprenes, polybutadienes, isobutene/isoprene copolymers, butadiene/styrene copolymers, butadiene/isoprene copolymers, isoprene/styrene copolymers and butadiene/styrene/isoprene copolymers.

22. The rubber composition according to claim 17, wherein the functionalized diene elastomer E2 is selected from the group consisting of polybutadienes and butadiene/styrene copolymers.

23. The rubber composition according to claim 17, wherein the functionalized diene elastomer E2 comprises at least one chemical function capable of interacting with the reinforcing filler, the chemical function comprising at least one heteroatom selected from the group consisting of nitrogen, sulfur, oxygen, phosphorus, tin and silicon.

24. The rubber composition according to claim 17, wherein the glass transition temperature TgE1 is within a range extending from -50° C. to 0° C.

25. The rubber composition according to claim 17, wherein the content of the non-functionalized diene elastomer E1 is within a range extending from 50 phr to 70 phr.

26. The rubber composition according to claim 17, wherein the non-functionalized diene elastomer E1 is selected from the group consisting of synthetic polyisoprenes, polybutadienes, butadiene/styrene copolymers, butadiene/isoprene copolymers, isoprene/styrene copolymers and butadiene/styrene/isoprene copolymers.

27. The rubber composition according to claim 17, wherein the non-functionalized diene elastomer E1 is selected from the group consisting of polybutadienes and styrene/butadiene copolymers.

28. The rubber composition according to claim 17, wherein a content of the reinforcing filler is within a range extending from 20 to 100 phr.

29. The rubber composition according to claim 17, wherein the reinforcing filler predominantly comprises at least one inorganic reinforcing filler.

30. The rubber composition according to claim 17, wherein a content of the functionalized diene elastomer E2 is less than or equal to 40 phr.

31. A tread comprising at least one rubber composition according to claim 17.

32. A pneumatic or non-pneumatic tire comprising at least one rubber composition according to claim 17.
